(19) United States
(12) Patent Application Publication
(10) Pub. No.: US 2020/0060455 A1
(43) Pub. Date: Feb. 27, 2020

(54) Controlled Portion Dietary Utensil

(71) Applicant: Sharif Hussein, Odessa, FL (US)

(72) Inventor: Sharif Hussein, Odessa, FL (US)

(21) Appl. No.: 16/109,043

(22) Filed: Aug. 22, 2018

(51) Int. Cl. A47G 21/02; A47J 43/28

(52) U.S. Cl. CPC A47G 21/023; A47J 43/28

(57) ABSTRACT

A fork for controlling the size of portions of food eaten is disclosed. The fork has shortened prongs attached to a scoop section. The scoop section is attached to a handle. The prongs and scoop section are designed to limit the portion of food that may be carried by the fork and thereby force a dieter to digest smaller portions for the same motions as required by a normal fork for a normal portion.

### TECHNICAL FIELD

The present disclosure relates generally to eating utensils, and more specifically to a portion fork that may be used to control portions for dietary needs.

### BACKGROUND

It is a well-known and continual goal for persons to live healthier lifestyles. One proven method to improve health and lifestyle is dieting. Effective dieting allows a person to reduce their weight and has other beneficial effects. Although many diets focus on the type of food a person should consume, it has been found that relatively simple methods, such as controlling the size of portions is effective regardless of the type of food consumed. Thus, enforcing portion control for food intake based on a predetermined number of caloric intake can enhance the effectiveness of many diets.

Unfortunately, diets are difficult to adhere to. The benefits of a diet cannot be realized if a dieter does not adhere to the parameters prescribed by the diet. For example, portion control to minimize caloric intake is only effective is a dieter actually maintains the portion control for each meal. One problem with effective portion control is the perception of a dieter of feeling hunger after completing a portion. This desire results in deviating from the portion control and thereby eating more food than allocated by the portion designed in the diet. The additional food consumed will reduce the effectiveness of the diet. Typically, carefully measured portions may be perceived as inadequate when a dieter is accustomed to larger portions. Dieters often eat additional portions to compensate for the now smaller portions.

Thus, there is a need for an eating utensil that assists in controlling the intake portion. There is a further need for sizing a fork to incentive a user to take more effort to eat portions thereby controlling food intake. There is a further need for a fork that only allows taking in smaller amounts in each fork full of a portion thereby creating the perception that the portion is a normal portion.

### SUMMARY

One disclosed example is a dietary eating utensil including a handle having a distal end and a proximal end. A scoop portion is coupled to the proximal end of the handle. A plurality of prongs projects from the scoop portion. The length of the prongs is predetermined to limit the portions of food to be carried on the scoop portion.

Another disclosed example is a method of controlling the intake of food. A dieter is provided a smaller portion of food than a normal serving of food. The dieter is provided a dietary eating utensil for consuming the smaller portion of food. The utensil includes a handle having a distal end and a proximal end. The utensil includes a scoop portion coupled to the proximal end of the handle. The utensil includes a plurality of prongs projecting from the scoop portion. The length of the prongs is predetermined to limit the portions of food to be carried on the scoop portion. The number of motions to eat the smaller portion of food is approximately the same as the number of motions required to eat a normal portion of food using a standard fork.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1 is a top view of an example dietary eating utensil;

FIG. 2 is a perspective view of the example dietary eating utensil in FIG. 1; and

FIG. 3 is a perspective view of the dietary eating utensil in comparison with a portion from a normal fork.

The present disclosure is susceptible to various modifications and alternative forms, and some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at, near, or nearly at,” or “within 3-5% of,” or “within acceptable manufacturing tolerances,” or any logical combination thereof, for example.

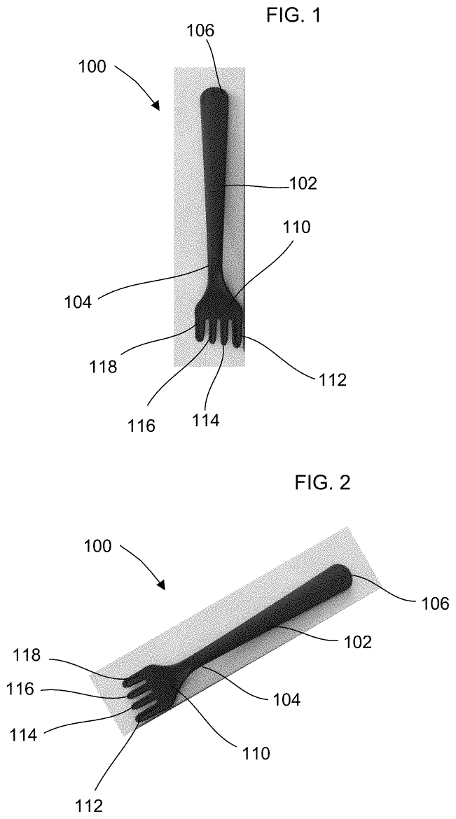

FIG. 1 is a perspective view of an example dietary fork 100. The fork 100 has an elongated handle 102 having a distal end 104 and a proximal end 106. In this example, the handle 102 is slightly tapered from a wider distal end 104 to a narrower proximal end 106. The proximal end 106 of the handle 102 is connected to a scoop section 110. The handle 102 may be textured to provide a better grip for a user.

The scoop section 110 has a series of four short prongs 112, 114, 116 and 118. The short prongs 112, 114, 116 and 118 are specifically designed to limit the portions that can be picked up by a user in the scoop section 110. The length of the prongs 112, 114, 116 and 118 are therefore shorter than the prongs of conventional fork. In this example, the fork 100 has a length of approximately 5.5 inches and the prongs 112, 114, 116 and 118 are about one inch long. In this example, the overall length of the scoop section including the prongs 112, 114, 116 and 118 is approximately one inch while the width of the scoop section 110 is approximately one inch. The individual prongs 112, 114, 116 and 118 may be approximately between 0.5 and 0.6 inches in length. The overall dimensions of the fork 100 are thus smaller than a conventional fork. For example, a standard fork may include prongs that are 1.5 inches long, 1.75 inches long, or 1.3 inches long with the scoop section, including the prongs, being between 2.0 and 2.4 inches in length. Thus, the length of the prongs in a standard fork may be approximately 2.5 to 3.5 times the length of the prongs in the example dietary fork 100. The length of the scoop portion of a standard fork may be approximately 2 to 2.5 times the length of the scoop portion of the example dietary fork 100.

The area of the scoop section 110 and the length of the prongs 112, 114, 116 and 118 are designed to reduce the portions of food that may be carried by the fork 100. Thus, the scoop section 110 enables the proper amount of food to be on the fork 100 for a person trying to consume food slower or in a more mindful fashion. In this example, the prongs 112, 114, 116 and 118 have different lengths that follow a predetermined angle from the perpendicular plane from the handle 102. In this example, the prong 118 is the shortest prong, while the prong 112 is the longest prong. Of course, the prongs 112, 114, 116 and 118 may also have an identical length.

Of course the number of prongs may be greater or less than four prongs in the example fork 100. For example, the same principles may be applied for a fork with only three prongs. The shape of the prongs 112, 114, 116 and 118 are generally rectangular in this example, but the prongs could be tapered or triangular in shape. The prongs 112, 114, 116 and 118 are generally curved in this example to follow a curvature of the scoop section 110. In this example, the fork 100 is fabricated from plastic, but other materials such as wood or metal may be used. The fork 100 may include ornamental designs and may have a specific color or pattern to allow identification of the fork 100.

The example portion fork 100 is a utensil designed for the needs of those where portion control of dietary needs is crucial for health. The size of the scoop section 110 and the prongs 112, 114, 116 and 118 limit the bite size from food carried by the fork 100. Thus a person using the fork 100 has the effect of slowing down eating for a more “full feeling” with less than half a normal portion of food.

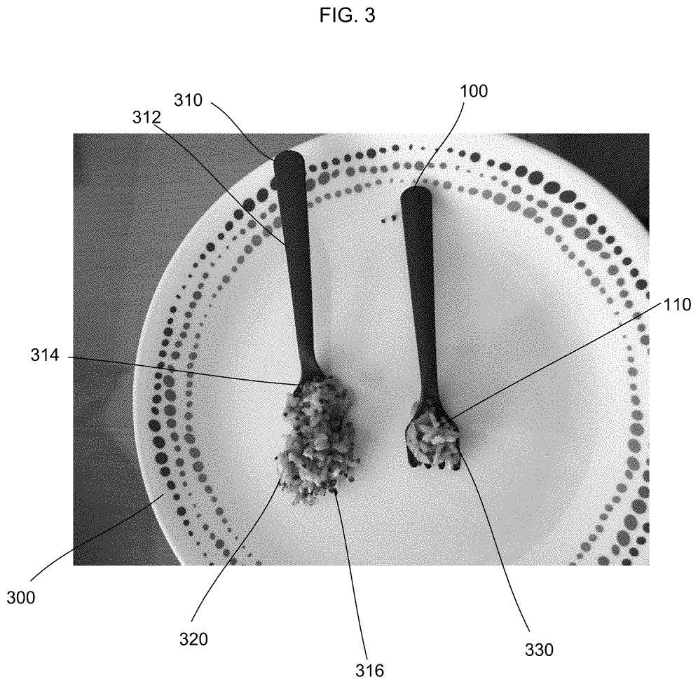

FIG. 3 shows a plate 300 that includes the example fork 100 in comparison with a typical fork 310. As may be seen in FIG. 3, the typical fork 310 has a longer handle 312 and a larger scoop portion 314. The prongs 316 of the typical fork 310 are also relatively long. As may be seen in FIG. 3, a food portion 320 that may be picked up by the typical fork 310 is relatively large. In comparison, when a user uses the portion fork 100, a smaller portion of food 330 is carried on the scoop portion 110, as both the scoop portion 110 and the prongs 112, 114, 116 and 118 are smaller in size. Since the portion of food 330 is relatively smaller using the example portion fork 100, a dieter perceives that the amount of food consumed for a smaller overall portion is the same as a larger portion using the typical fork 310. This perception is reinforced by the use of the portion fork 100 that requires 2 to 3 times the number of motions as employed by a normal fork 300 in eating the same amount of food. Thus, since a dieter is used to a certain number of forkfuls to eat a food serving, by using the portion fork 100, the dieter eats a smaller portion such as roughly half the amount of a normal portion while perceiving the intake of a normal sized portion.

In this example, a normal portion may be 13 ounces, but the example fork 100 is designed to carry approximately 3-4 ounces. Thus, the example portion fork 100 may be designed to convey a predetermined fraction of the portion of a normal fork. The predetermined fraction may be scaled based on the size of the normal fork. Further, the size of the specific portion may also dictate the dimensions of the portion fork 100.

The example fork 100 may be used for any application requiring control of food portions for a person. For example, hospitals and other health care institutions may use the example portion fork 100 for diets of patients undergoing post operation recovery. The example fork 100 may be used for patients that need to eat very small amounts and chew small amounts thoroughly before swallowing. For example, certain patients such as children, the elderly or the very ill may be more susceptible to choking hazards. Use of the portion fork 100 controls the size of the portions to be digested and therefore decreases the risk of choking in such patients.

The example fork 100 may be used for dieting. As explained above, the use of the fork 100 allows eating smaller meals and getting benefit of “full feeling” of a bigger and higher caloric meal without over consuming. Smaller meals will take more than double the amount of time thus giving the consumer satiation by increasing food exposure time up to 20 minutes, the scientific time when hunger is no longer felt after consumption with less than half the amount of food. Thus, the length of the prongs 112, 114, 116 and 118 are designed to cut down the portions that may be carried by the example fork 100.

Another application of the example portion fork 100 is mindfulness in eating. Users practice mindfulness through eating where the process involves full attention on the actual eating process including chewing, taste and swallowing. The mindfulness of the eating process gives a consumer more time to practice a mindful experience with out over consuming food. Mindful practice is scientifically linked to less stress, clearer thinking, and less health problems in a person's lifestyle. Many practice mindfulness through eating because it is one of the easiest forms of mindfulness.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including”, “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A dietary eating utensil comprising:
a handle having a distal end and a proximal end;
a scoop portion coupled to the proximal end of the handle; and
a plurality of prongs projecting from the scoop portion, wherein the length of the prongs is predetermined to limit the portions of food to be carried on the scoop portion.

2. The dietary eating utensil of claim 1, wherein there are four prongs in the plurality of prongs.

3. The dietary eating utensil of claim 1, wherein there are three prongs in the plurality of prongs.

4. The dietary eating utensil of claim 1, wherein the handle, scoop portion and prongs are fabricated from plastic.

5. The dietary eating utensil of claim 1, wherein the handle, scoop portion and prongs are fabricated from metal.

6. The dietary eating utensil of claim 1, wherein the scoop portion and prongs have a curved shape.

7. The dietary eating utensil of claim 1, wherein the plurality of prongs have different lengths.

8. The dietary eating utensil of claim 1, wherein the plurality of prongs have identical lengths.

9. A method of controlling the intake of food comprising:
providing a dieter a smaller portion of food than a normal serving of food;
providing the dieter a dietary eating utensil for consuming the smaller portion of food, the utensil including:
a handle having a distal end and a proximal end;
a scoop portion coupled to the proximal end of the handle; and
a plurality of prongs projecting from the scoop portion, wherein the length of the prongs is predetermined to limit the portions of food to be carried on the scoop portion, wherein the number of motions to eat the smaller portion of food is approximately the same as the number of motions required to eat a normal portion of food using a standard fork.

10. The method of claim 9, wherein there are four prongs in the plurality of prongs.

11. The method of claim 9, wherein there are three prongs in the plurality of prongs.

12. The method of claim 9, wherein the handle, scoop portion and prongs are fabricated from plastic.

13. The method of claim 9, wherein the handle, scoop portion and prongs are fabricated from metal.

14. The method of claim 9, wherein the scoop portion and prongs have a curved shape.

15. The method of claim 9, wherein the plurality of prongs have different lengths.

16. The method of claim 9, wherein the plurality of prongs have identical lengths.
